(19) United States
(12) Patent Application Publication
(10) Pub. No.: US 2014/0009823 A1
(43) Pub. Date: Jan. 9, 2014

(54) METHOD OF MANUFACTURING POLARIZED LIGHT SPLITTING ELEMENT

(71) Applicant: LG CHEM, LTD., Seoul (KR)

(72) Inventors: Jeong Ho PARK, Daejeon (KR); Tae Su KIM, Daejeon (KR); Jae Jin KIM, Daejeon (KR); Jong Byung LEE, Daejeon (KR); Jin Mi JUNG, Daejeon (KR); Bu Gon SHIN, Daejeon (KR)

(73) Assignee: LG CHEM, LTD., Seoul (KR)

(21) Appl. No.: 13/971,561

(22) Filed: Aug. 20, 2013

Related U.S. Application Data
(63) Continuation of application No. PCT/KR2012/011313, filed on Dec. 21, 2012.

(30) Foreign Application Priority Data
Dec. 22, 2011 (KR) 10-2011-0140287
Dec. 21, 2012 (KR) 10-2012-0151109

(51) Int. Cl. G02B 5/30

(52) U.S. Cl. CPC G02B 5/3075
USPC 359/352; 427/160; 216/24

(57) ABSTRACT

Provided are a method of manufacturing a polarized light splitting element, a polarized light splitting element, a light radiating device, a method of radiating light, and a method of manufacturing an orientationally-ordered photoalignment layer. The method of manufacturing a polarized light splitting element has a simple manufacturing process and a low production cost, and may be used to easily manufacture a large-scale UV ray polarized light splitting element. In addition, the polarized light splitting element may have excellent durability to UV rays and heat, and a low pitch dependency on a polarization characteristic, thereby facilitating performance of the manufacturing process, and excellent polarity in a short wavelength region.

### CROSS-REFERENCE TO RELATED APPLICATION

This application claims priority to and the benefit of Korean Patent Application Nos. 2011-0140287, filed Dec. 22, 2011, 2012-0151109, filed Dec. 21, 2012, the disclosure of which is incorporated herein by reference in its entirety.

### BACKGROUND

1. Field of the Invention

The present application relates to a method of manufacturing a polarized light splitting element, a polarized light splitting element, a light radiating device, a method of radiating light, and a method of manufacturing an orientationally ordered photoalignment layer.

2. Discussion of Related Art

A liquid crystal alignment layer used to arrange liquid crystal molecules in a certain direction is being applied in various fields. The liquid crystal alignment layer serves as a surface treated by radiating light and may be a photoalignment layer capable of arranging adjacent liquid crystal molecules. Conventionally, the photoalignment layer may be manufactured by radiating light, for example, linearly polarized light, to a surface of a layer of a photosensitive material to orientationally order the photosensitive material in a certain direction.

To radiate linearly polarized light to the photoalignment layer, various kinds of polarized light splitting element may be used, and the polarized light splitting elements may be manufactured by various methods.

For example, in Korean Patent Application Publication No. 2011-0033025, a method of manufacturing a UV ray polarized light splitting element by forming an antireflection layer on a substrate, forming a photosensitive layer on the antireflection layer, forming a wire grid pattern by selectively exposing and developing the photosensitive layer using a laser, and depositing a metal on the wire grid pattern as the polarized light splitting element is disclosed.

### SUMMARY OF THE INVENTION

The present application is directed to providing a method of manufacturing a polarized light splitting element, a polarized light splitting element, a light radiating device, a method of radiating light, and a method of manufacturing an orientationally ordered photoalignment layer.

One aspect of the present application provides a method of manufacturing a polarized light splitting element including forming a concavo-convex portion on a substrate by a solution process, and the polarized light splitting element manufactured thereby may generate linearly polarized light in a UV wavelength band. The term “UV region” used herein refers to a region of light having a wavelength of 250 to 350, 270 to 330, or 290 to 310 nm. Hereinafter, with reference to the accompanying drawings, the polarized light splitting element will be described in detail.

In one example, the method of manufacturing a UV ray polarized light splitting element may include forming a convex part including a light absorbing material by a solution process. The solution process refers to a coating process using a solution, and in one exemplary embodiment, the solution process may include a sol-gel process. Here, the sol-gel process refers to a process in which water is added to a sol-state solution, that is, a solution in which micro-colloidal particles generated by hydrolysis and polymerization/condensation using an organic metal precursor as a starting material are dispersed on an organic dispersing agent to further perform hydrolysis and condensation, thereby thickening the sol at a certain concentration or more, and then the sol is gelated into a gel which is hardened due to a solid network structure and coated. Particularly, the sol-gel process may refer to a coating process by coating a sol-state coating solution including light absorbing nanoparticles or a precursor of a light absorbing material, and forming a silicon coating layer by addition of water and gelation. Since this process can form a convex part including a light absorbing material by a solution process without vacuum-depositing a light absorbing material on a substrate as described above, it does not need an expensive vacuum deposition apparatus, and thus economic feasibility of the process may be enhanced and manufacture of a large-scale product may be more effectively realized.

FIG. 1 is a diagram sequentially illustrating a method of manufacturing a UV ray polarized light splitting element, and FIG. 2 is a diagram sequentially illustrating another method of manufacturing a UV ray polarized light splitting element.

As shown in FIG. 1, in the manufacturing method of the present application, a convex part 141 may be formed by forming a resist 120 in a grid shape having regular gaps on a substrate 110, and coating the coating solution 130 in the gap of the grid by the solution process described above. As described above, when the resist 120 is previously formed, and the convex 141 part is formed by the solution process, the coating solution may coat a concave part 142 formed by the convex part 141 to have a thickness not higher than a height of the convex part 141. Accordingly, a concavo-convex portion 140 having a desired pitch or height may be easily formed, and an additional etching process is not needed, and thus efficiency may be increased in terms of economic feasibility of the process. The term “grid” used herein refers to a structure of the concavo-convex portion 140 in which at least two grooves are formed at regular intervals in a plane, and thus stripe patterns formed by a plurality of concave parts 142 and convex parts 141 are parallel to each other.

In another embodiment of the manufacturing method, as shown in FIG. 2, a convex part 241 may be formed by forming a layer 220 of a coating solution including a light absorbing material by coating a coating solution on a substrate 210 by the solution process as described above, forming a resist 230 on the layer 220 of the coating solution and etching the layer 220. The term “resist” used herein refers to an organic polymer material or metal thin film coated on a part not to be etched to etch only a desired part.

In one example, the coating solution 130 or 220 may include light absorbing particles or a precursor of a light absorbing material, and preferably, both of the light absorbing particles and the precursor of a light absorbing material.

In one example, an average diameter of the light absorbing particles may vary depending on pitches, widths or heights of the convex part 141 or 241 and the concave part 142 and 242 of the desired UV ray polarized light splitting element 100 or 200. For example, the average diameter of the particles may be, but is not limited to, 100 nm or less. When the average diameter of the particles is more than 100 nm, a preferable pattern may not be formed because the average diameter of the particles may be similar to or greater than the widths and sizes of the concave and convex parts of the resist 120 or 230, and an effective UV splitting characteristic may not be expected due to a severe scattering phenomenon of light with respect to a UV wavelength in the manufactured polarized light splitting element 100 or 200. The lower limit of the average diameter of the particles may be, but is not particularly limited to, 3 nm in consideration of manufacturability, since the present application may use particles having a smaller diameter than the width of the convex part 141 or 241 of the manufactured polarized light splitting element 100 or 200.

In addition, the light absorbing particles may be, but are not particularly limited to, particles capable of absorbing light in a UV region, for example, particles satisfying conditions that a refractive index be 1 to 10 and an extinction coefficient be 0.5 to 10 with respect to light having a wavelength of 300 nm. For example, the particles may be, but are not limited to, one or an alloy of at least two selected from the group consisting of titanium oxide particles, zinc oxide particles, zirconium oxide particles, tungsten oxide particles, tin oxide particles, cesium oxide particles, strontium titanium oxide particles, silicon carbide particles, iridium particles, iridium oxide particles and silicon particles, and preferably titanium dioxide (TiO₂) particles. For example, the polarized light splitting element 100 or 200 using the titanium dioxide particles may have an excellent polarization degree in the UV region due to the absorbing coefficient in the UV region of 1 or more, and durability may also be enhanced due to degradation in a polarization characteristic by oxidation compared to that using aluminum.

A shape of the exemplary particle may be a sphere, or a polyhedron such as a pyramid (tetrahedron), a cube (hexahedron) or a higher order polyhedron, or another shape such as a circular plate, an oval shape or a rod shape, but the present application is not particularly limited thereto.

The light absorbing particles in the coating solution 130 or 220 may be included at 1 to 30, 5 to 20, 15 to 25 or 10 to 18 parts by weight with respect to 100 parts by weight of the coating solution. When the light absorbing particles are included at less than 1 part by weight, the light absorbing particles may not be coated in a uniform layer or may not uniformly fill a lower part of a gap of the grid due to a relatively low density of the light absorbing particles, and when the light absorbing particles are included at more than 30 parts by weight, due to a relatively high solid content, it may be difficult to control the light absorbing particles to fill the gap of the grid or to form a uniform thin film during the process.

In the coating solution 130 or 220, to disperse the light absorbing particles, various solvents may be used according to the kind of light absorbing particles, but the present application is not particularly limited. The solvent may be distilled water, an alcohol-based solvent such as methanol, ethanol, butanol or isopropyl alcohol or ethoxy acetate as a polar solvent, or toluene, xylene, hexane or octane as a non-polar solvent.

In one example, the precursor of a light absorbing material may form micro particles having a small diameter due to hydrolysis and condensation, and to form a fine pattern using micro particles formed by the precursor of a light absorbing material as described above, the precursor of a light absorbing material may be used in the sol-gel process.

In one example, the precursor of a light absorbing material may be any layer of the light absorbing material or precursor capable of forming the light absorbing particles described above satisfying the ranges of refractive index and extinction coefficient in the above ranges by hydrolysis and condensation in the sol-gel process without particular limitation. The precursor may be, but is not limited to, at least one selected from the group consisting of titanium alkoxide, zirconium alkoxide, tungsten alkoxide, tin alkoxide, zinc alkoxide, cesium alkoxide, iridium alkoxide and silicon alkoxide, and preferably titanium alkoxide or silicon alkoxide.

The precursor of a light absorbing material may be included at 1 to 40, 5 to 30, 20 to 35 or 10 to 25 parts by weight with respect to 100 parts by weight of the coating solution in the coating solution 130 or 220. When the precursor of a light absorbing material is included at less than 1 part by weight, due to a relatively large amount of organic compound in the coating solution, the particles may be drastically decreased in volume in a sintering process to remove the organic compound in the coating solution in a solution process using the precursor, and thus it may be difficult to realize a uniform film or grid. When the precursor of a light absorbing material is included at more than 40 parts by weight, hydration may rapidly progress due to a trace of moisture even when the process is performed in a glove box filled with nitrogen, the precursor may harden before a film or grid having a desired shape is formed, and thus a reaction rate may be difficult to control.

In one example, the coating solution 130 or 220 may be a sol-gel solution including an alcohol-based solvent and an acid or base catalyst, as well as the precursor of a light absorbing material described above.

Here, the alcohol-based solvent may include at least one alcohol selected from the group consisting of isopropanol, methanol, ethanol and butanol. The alcohol-based solvent may be included at 50 to 90, 60 to 80 or 70 to 75 parts by weight with respect to 100 parts by weight of the sol-gel coating solution. When the alcohol-based solvent is included at less than 50 parts by weight, a precipitate is generated, and it is difficult to realize a film having a uniform layer, and when the alcohol-based solvent is included at more than 90 parts by weight, a content of an absorbing material finally formed, that is, a solid, is small, and thus the formation of a continuous pattern or grid may be difficult.

Here, the acid or base catalyst may include at least one selected from the group consisting of hydrochloric acid, nitric acid, acetic acid, ammonia, potassium hydroxide and an amine-based compound, but the present application is not particularly limited thereto. In one example, a metal oxide precursor may use an acid catalyst since it increases stability of an oxide derivative under an acid condition, thereby preventing precipitation, and inducing uniform gelation. In this case, a suitable pH of the sol-gel solution may be changed depending on the kind of precursor of the light absorbing material. For example, stability of the precursor solution may be obtained at pH of 2 to 5.

The acid or base catalyst may be included at 1 to 30, 5 to 20, or 10 to 15 parts by weight with respect to 100 parts by weight of the sol-gel coating solution. When the catalyst is included at less than 1 part by weight, a viscosity of the solution is rapidly increased due to rapid hydration and condensation with moisture in the air, and when the catalyst is included at more than 30 parts by weight, a thin film having a desired thickness may not be obtained due to delay of the gelation by hydration and condensation, or a desired film and grid shape may not be obtained due to a large decrease in volume after the sintering process because a content of the organic compound included in the coating solution is relatively increased.

In one example, the coating solution 130 or 220 may further include both of a precursor of a light absorbing material and light absorbing particles to relatively reduce volume contraction by the removal of an organic compound of the precursor of a light absorbing material or a light absorbing material in a sintering process to be described later. For example, as the coating solution 130 or 220, a mixed solution in which the precursor of a light absorbing material is mixed with light absorbing particles including a material the same as or different from the light absorbing material formed from the precursor of a light absorbing material by dehydration and condensation may be used, and preferably, the light absorbing particles include a material the same as the light absorbing material formed from the precursor of a light absorbing material. When the light absorbing particles include the same kind of material as the light absorbing material formed from the precursor of a light absorbing material as described above, non-uniformity of a composition may be minimized because of a phase separation phenomenon between a different kind of light absorbing particles and a light absorbing precursor mixture in a high-temperature sintering process.

A weight ratio of the light absorbing particles with respect to the precursor of a light absorbing material may be 0.1 to 50, 1 to 30 or 5 to 20 parts by weight with respect to 0.1 to 50 parts by weight of the precursor of a light absorbing material. When the light absorbing particles are included at more than 50 parts by weight, a solid content in the light absorbing material finally formed is relatively high, and thus it may be difficult to effectively fill the particles in a gap of the resist grid and form a uniform thin film and a fine pattern having high reliability. In addition, when the particles are included at less than 0.1 parts by weight, it may be difficult to obtain an effect caused by reduction of the decrease in volume.

As described above, when the coating solution 130 or 220 includes both of the precursor of a light absorbing material and the light absorbing particles, in one example, the particles may have a core shell structure. For example, the particles may include a core including a metal or a metal alloy, and a shell present outside the core and including an organic compound, a metal oxide or a metal or metal alloy different from that of the core. Since the core shell-structure particles may have a large specific surface area, the particles may not be cohered or solidified and may be more highly dispersed.

In one example, the organic compound may be a ligand or polymer compound binding to the outside of the core.

Here, the ligand may be, but is not limited to, at least one selected from oleic acid, stearic acid, palmic acid, 2-hexadecanone, 1-octanol, Span 80, dodecylaldehyde, 1,2-epoxydodecane, 1,2-epoxyhexane, arachidyl dodecanoate, octadecylamine, silane, alkanethiols (HS(CH₂)ₙX, X═CH₃; —OH, —COOH), dialkyl disulfides (X(CH₂)ₘS—S(CH₂)ₙX) and dialkyl sulfides (X(CH₂)ₘS(CH₂)ₙX)).

The polymer compound may be, but is not limited to, at least one selected from fluoropolymer, polyethylene glycol, polymethylmethacrylate, polylactic acid, polyacrylic acid, polysulfide, polyethylene oxide, a block copolymer including at least one functional group and nitrocellulose.

The coating solution 130 or 220 may be coated on a gap of the grid or on the substrate 110 or 210 using a coating method widely known in the related art, for example, spin coating, dip coating, spray coating, or bar coating, but the present application is not limited thereto.

In one example, the solution process may further include a sintering process to remove a solvent in the coating solution 130 or 220. For example, the solution process may be performed by coating the coating solution 130 or 220 on a gap of the grid of the resist 120 or on the substrate 110 or 210, and heating the coating solution at a predetermined temperature. The temperature for heating the coating solution 130 or 220 may vary depending on a kind of solvent constituting the solution in the range of 60 to 300° C., for example, 80 to 250, 100 to 200, 80 to 300. 100 to 250 or 150 to 300° C. When the temperature is less than 60° C. a solvent present in the grid or a film formed by gelation of the precursor is not completely removed, and thus the grid or film having a uniform shape is difficult to form in the sintering process, and when the temperature is more than 300° C., a defect such as local formation of pores in the film or grid may occur due to rapid evaporation of the solvent. As the solvent of the coating solution 130 or 220 is completely removed by the sintering process, a gap between the light absorbing particles may be decreased, a density of the light absorbing material in the convex part 141 or 241 may be increased, and a degree of binding between the light absorbing particles may be increased, resulting in achieving high physical stability. In addition, organic materials binding to the precursor of a light absorbing material or the light absorbing particles may be completely removed by the sintering process, and a crystal structure having excellent absorbance in a UV wavelength band may be formed.

In one example, the resist 120 or 230 may be formed by various methods known in the related art, for example, photolithography, nano imprint lithography, soft lithography or interference lithography. For example, the resist 120 or 230 may be formed by coating a resist material on the substrate 110 or 220 or the layer 220 of coating solution including a light absorbing material, and exposing and developing the coated surface in a desired pattern using a mask, but the present application is not limited thereto.

As shown in FIG. 2, the convex part 241 may be formed by an etching process such as dry or wet etching the resist 230 formed on the layer 220 of coating solution using a mask as described above.

The wet etching refers to a method of etching the layer 220 of coating solution using an etching solution, for example, a method of dipping the layer 220 of coating solution into a strong base solution such as KOH or tetramethylammonium hydroxide (TMAH), a strong acid solution such as fluoric acid (HF) or an etching solution using a mixture of HF, HNO₃ and acetic acid (CH₃COOH). In one example, an additive such as isopropylalcohol (IPA) or a surfactant may be added to the etching solution.

Generally, since the wet etching is etching having the same etching rates in vertical and horizontal directions, known as isotropic etching, it is not suitable for forming a pattern having a high aspect ratio. However, since the polarized light splitting element 100 or 200 includes a light absorbing material having the above-described refractive index and extinction coefficient required to obtain a polarization degree, an aspect ratio is not high. Therefore, the concavo-convex portion 140 or 240 may be formed using wet etching. In this case, a production cost may be considerably reduced, and a process rate may be increased, compared to the dry etching.

In one example, the layer 220 of coating solution may selectively use isotropic or anisotropic etching according to a crystal direction. For example, when wet etching is performed on the layer 220 of coating solution having a crystal direction of 100, isotropic etching having the same etching rate in all directions is performed. However, when the crystal direction of the layer 220 of coating solution is the 110 direction and a strong base such as KOH is used, the 111 direction is not substantially etched, and thus anisotropic etching performed in only one direction may be realized. According to such characteristics, anisotropic etching having a high aspect ratio may be realized through the wet etching.

In one example, the dry etching is a method of etching the layer 220 of coating solution using a gaseous gas. Known dry etching methods including ion-beam etching, RF sputter etching, reaction ion etching and plasma etching may be used, but the present application is not limited thereto.

To etch the layer 220 of coating solution by dry etching, in order to increase etchability, the layer 220 of coating solution is formed, and a hard mask layer may be formed between the resist 230 and the layer 220 of coating solution before forming the resist 230. The hard mask layer may be formed of any material which is more easily etched than the resist 230 but etched less than the layer 220 of coating solution, for example, Cr, Ni, SiN or SiO₂. However, the present application is not particularly limited thereto. Here, when the hard mask layer is further added, an etching ratio is considerably increased compared to when only the resist 230 is used as an etching mask, and therefore a pattern having a high aspect ratio may be easily manufactured.

When a concavo-convex portion is formed using the resist 230, the resist 230 may be removed, and the hard mask layer may also be removed by the dry etching after the concavo-convex portion 240 is formed. The resist 230 or hard mask layer is not particularly limited, and may be removed though resist burning by heating or dry etching.

Here, in the resist burning, a heating temperature may vary depending on the kind of light absorbing material or precursor of a light absorbing material to be used, and may be in the range of 250 to 900° C., 300 to 800° C., 350 to 700° C., 300 to 500° C., 350 to 600° C., 400 to 800 or 450 to 900° C. When the heating temperature is less than 250° C., durability may be degraded since organic materials are not completely removed, and when the heating temperature is more than 900° C., a light absorbing characteristic in the UV region may be degraded due to the change in a metal oxide crystal. Particularly, when the heating temperature is 350 to 700° C., in the sol-gel coating solution 130 or 220, organic compounds binding to the precursor of a light absorbing material or light absorbing nanoparticles may be effectively removed, and thus light absorption in the UV region may be activated. When the resist 230 is removed through resist burning, surface treating materials introduced to disperse the light absorbing material or precursor of a light absorbing material may be removed along with the resist 230.

In the exemplary manufacturing method, the convex part may be formed such that a dielectric material is present in the concave part formed by the convex parts. Here, the dielectric material present in the convex and concave parts may be formed such that a is 0.74 to 10 and b is 0.5 to 10 in Formula 1.

(a+bi)²=n₁²×(1−W/P)+n₂²×W/P [Formula 1]

In Formula 1, i is a unit of an imaginary number, n₁ is one of wavelengths of the dielectric material in the UV region of 250 to 350 nm, for example, a refractive index with respect to light having a wavelength of 300 nm, n₂ is one of wavelengths of the convex part 141 or 241 in the UV region of 250 to 350 nm, for example, a refractive index with respect to light having a wavelength of 300 nm, W is a width of the convex part 141 or 241, and P is a pitch of the convex part 141 or 241.

When the pitch (P) of the convex part 141 or 241 of the concavo-convex portion 140 or 240 is formed to satisfy Formula 1, even in the pitch range of 120 nm or more, the polarized light splitting element 100 or 200 having a high polarization degree of 0.5, 0.6, 0.7 or 0.9 or more in a short wavelength region, for example, the light wavelength region of 250 to 350 nm may be obtained. The upper limit of the polarization degree may be, but is not particularly limited to, 0.98, 0.95 or 0.93 or less in consideration of economic feasibility of the manufacturing process. That is, when the polarization degree is more than 0.98, an aspect ratio (width/height of the convex) of the concavo-convex portion 140 or 240 of the polarized light splitting element 100 or 200 should be increased. In this case, the polarized light splitting element 100 or 200 may be difficult to manufacture, and the manufacturing process may become complicated. The term “polarization degree” used herein refers to an intensity of polarized light with respect to the intensity of radiated light, and is calculated by Formula 3.

Polarization Degree (D)=(Tc−Tp)/(Tc+Tp) [Formula 3]

Here, Tc is a transmittance of light having a wavelength of 250 to 350 nm and polarized in a direction perpendicular to the convex part 141 or 241 with respect to the polarized light splitting element 100 or 200, and Tp is a transmittance of light having a wavelength of 250 to 350 nm and polarized in a direction parallel to the convex part 141 or 241 with respect to the polarized light splitting element 100 or 200. Here, the term “parallel” refers to substantially parallel, and the term “vertical” refers to substantially vertical.

In addition, in one example, the concavo-convex portion 140 or 240 may be formed such that c is 1.3 to 10 and d is 0.013 to 0.1 in Formula 2.

(c+di)²=n₁²×n₂²/((1−W/P)×n₂²+W×n₁²/P)

In Formula 2, i is a unit of an imaginary number, n₁ is one of wavelengths of the dielectric material in the UV region of 250 to 350 nm, for example, a refractive index with respect to light having a wavelength of 300 nm, n₂ is one of wavelengths of the convex part 141 or 241 in the UV region of 250 to 350 nm, for example, a refractive index with respect to light having a wavelength of 300 nm, W is a width of the convex part 141 or 241, and P is a pitch of the convex part 141 or 241.

When the pitch (P) of the convex part 141 or 241 of the concavo-convex portion 140 or 240 is formed to satisfy Formula 2, a suitable transmittance to have an excellent polarized light splitting characteristic may be obtained, but absorbance is decreased. Therefore, the height of the convex part 141 or 241 may be decreased.

In addition, in the exemplary method of manufacturing the polarized light splitting element 100 or 200, the concavo-convex portion 140 or 240 may be formed such that a is 0.74 to 10 and b is 0.5 to 10 in Formula 1, and c is 1.3 to 10 and d is 0.013 to 0.1 in Formula 2.

(a+bi)²=n₁²×(1−W/P)+n₂²×W/P [Formula 1]

(c+di)²=n₁²×n₂²/((1−W/P)×n₂²+W×n₁²/P) [Formula 2]

In Formulas 1 and 2, i is a unit of an imaginary number, n₁ is one of wavelengths of the dielectric material in the UV region of 250 to 350 nm, for example, a refractive index with respect to light having a wavelength of 300 nm, n₂ is one of wavelengths of the convex part 141 or 241 in the UV region of 250 to 350 nm, for example, a refractive index with respect to light having a wavelength of 300 nm, W is a width of the convex part 141 or 241, and P is a pitch of the convex 141 or 241.

In Formulas 1 and 2, when all of a, b, c and d satisfy the above-described ranges due to low dependency on a polarization characteristic according to the pitch (P) of the polarized light splitting element 100 or 200, an excellent polarization degree may be realized in a short wavelength region, even when the concavo-convex portion 140 or 240 having a pitch of 120 nm or more is formed in the polarized light splitting element 100 or 200.

In one example, the pitch (P) of the convex part 141 or 241 may be, but is not particularly limited to, 50 to 200 nm, 100 to 180 nm, 110 to 150 nm, 120 to 150 nm, 130 to 150 nm or 140 to 150 nm.

In one example, a ratio (H/P) of the height (H) of the convex part 141 or 241 with respect to the pitch (P) of the convex part 141 or 241 may be 0.3 to 1.5, 0.4 to 1, 0.5 to 1.2, 0.6 to 1.3 or 0.8 to 1.5 in consideration of the pitch and line width of the grid of the polarized light splitting element 100 or 200 realized in the UV region. When the ratio (H/P) of the height (H) of the convex part 141 or 241 with respect to the pitch (P) of the convex part 141 or 241 is less than 0.6, sufficient light absorption may not be obtained, and when the ratio (H/P) of the height (H) of the convex part 141 or 241 with respect to the pitch (P) of the convex part 141 or 241 is more than 1.5, the polarized light splitting element 100 or 200 may be difficult to manufacture, and even when successfully manufactured, the polarization degree may be high but the light transmittance having the greatest influence on a rate of photoalignment may be drastically decreased.

The height (H) of the convex part 141 or 241 may be, but is not particularly limited to, 20 to 300 nm, 50 to 200 nm, 100 to 150 nm, 150 to 250 nm or 200 to 280 nm. When the height (H) of the convex part 141 or 241 is more than 300 nm, an amount of absorbed light is increased and thus an absolute amount of light required for photoalignment may be decreased. Accordingly, when the height (H) of the convex part 141 or 241 is in the above range, the suitable polarized light splitting element 100 or 200 may be possibly manufactured due to a small amount of absorbed light, and may have an excellent UV transmittance and exhibit active polarized light splitting performance. In addition, as the height (H) of the convex part 141 or 241 is increased at the same pitch (P), degradation in availability in manufacturing a pattern may be prevented.

The width (W) of the convex part 141 or 241 may be, but is not particularly limited to, 10 to 160 nm. Particularly, when the pitch of the convex part 141 or 241 is 50 to 150 nm, the width (W) of the convex part 141 or 241 may be 10 to 120 nm, 30 to 100 nm or 50 to 80 nm.

In one example, the concavo-convex portion 140 or 240 may be formed such that a fill-factor is between 0.2 and 0.8, for example, the fill-factor of the concavo-convex portion 140 or 240 may be 0.3 to 0.6, 0.4 to 0.7, 0.5 to 0.75 or 0.45. When the fill-factor of the concavo-convex portion 140 or 240 satisfies the above range, active polarized light splitting performance may be realized, and the degradation in polarization characteristic of the polarized light splitting element 100 or 200 may be prevented due to a small amount of absorbed light. The term “fill-factor” of the concavo-convex portion 140 or 240 used herein refers to a ratio (W/P) of the width (W) of the convex part 141 or 241 to the pitch (P) of the convex part 141 or 241. In addition, the “polarization characteristic” refers to a characteristic in which, among the components of light radiated to the polarized light splitting element 100 or 200, P polarized light is transmitted and S polarized light is absorbed or reflected by the polarized light splitting element 100 or 200. The term “S polarized light” used herein refers to a component of incident light incident on an absorbing polarizing plate, which has an electric field vector parallel to the grid, and the term “P polarized light” refers to a component of incident light incident on an absorbing polarizing plate, which has an electric field vector perpendicular to the grid.

Another aspect of the present application provides a polarized light splitting element.

FIG. 3 is a schematic diagram of an exemplary polarized light splitting element 100, and FIG. 4 is a schematic diagram of a top surface of the exemplary polarized light splitting element 100. As shown in FIGS. 3 and 4, the polarized light splitting element 100 may include the concavo-convex portion 140 having a convex part 141 including a light absorbing material and a concave part 142 in which a dielectric material is present. The term “concavo-convex portion” used herein is a structure in which stripe patterns including a plurality of the concave parts 142 and convex parts 141 are arranged in parallel (refer to FIG. 4), and the term “pitch (P)” used herein refers to a length of a width (W) of the convex part 141 and a width of the concave part 142, and the term “height” used herein refers to a height (H) of the convex part 141 (refer to FIG. 3).

As shown in FIG. 3, the exemplary polarized light splitting element 100 may include the concavo-convex portion 140, which may have a concave part 142 and a convex part 141. Here, the convex part 141 may include a light absorbing material. For example, the light absorbing material may have any one of wavelengths in the UV region of 250 to 350 nm, for example, a refractive index with respect to light having a wavelength of 300 nm, of 1.3 to 8, 1.5 to 9, 2 to 7 or 3 to 4. The polarized light splitting element 100 formed of a light absorbing material having a refractive index of less than 1 may not have an excellent extinction ratio. The term “extinction ratio” used herein refers to Tc/Tp, and as the extinction ratio is increased, it may be assumed that a polarizing plate has excellent polarization performance. Here, Tc is a transmittance of light having a wavelength polarized in a direction perpendicular to the convex part 141 with respect to the polarized light splitting element 100, and Tp refers to a transmittance of light polarized in a direction parallel to the convex part 141 with respect to the polarized light splitting element 100. In addition, the light absorbing material may have an extinction coefficient with respect to light having a wavelength in the range of 250 to 310 nm, for example, 300 nm, of 1 to 5. 1.2 to 7, 1.3 to 5 or 1.5 to 3. When the convex part 141 is formed of a material having an extinction coefficient satisfying the above range, the polarized light splitting element 100 may have a high extinction ratio, and an excellent transmittance as a whole.

Particularly, when the convex part 141 includes a light absorbing material having a refractive index with respect to light having a wavelength in the range of 250 to 310 nm, for example, 300 nm, of 1 to 10, and an extinction coefficient of 0.5 to 10, light in the UV region may be polarized without limitation to the pitch of the convex part 141. That is, since the convex part 141 has a refractive index with respect to light having a wavelength in the range of 250 to 310 nm, for example, 300 nm, of 1 to 10, and an extinction coefficient of 0.5 to 10 due to the light absorbing material, a dependency to the pitch (P) in the case of polarizing light in the UV region may be lower than that of a reflective material such as aluminum. In addition, to polarize light in the UV region, which has a short wavelength, the convex part 141 formed of the light absorbing material may have a pitch of 50 to 200 nm, 100 to 180 nm, 110 to 150 nm, 120 to 150 nm, 130 to 150 nm or 140 to 150 nm. When the pitch (P) is approximately half the wavelength region of 400 nm, for example, more than 200 nm, polarized light may not be split in the UV region. Since the convex part 141 also has the refractive index and extinction coefficient in the above range, the convex part 141 has high UV absorbability, and an excellent extinction ratio in a short wavelength than aluminum. Therefore, the polarized light splitting element 100 having an excellent UV polarization degree may be manufactured using the light absorbing material. In one example, an oxidation temperature of the light absorbing material may be 400° C. or more, and particularly, 500, 600, 700 or 800° C. or more. When the convex part 141 is formed of the light absorbing material having the above oxidation temperature, the oxidation temperature of the light absorbing material is increased, and thus the polarized light splitting element 100 having excellent thermal stability and durability may be obtained. Accordingly, when light generated from a backlight or light source, particularly, light in the UV region, is polarized, oxidation is caused by heat generated by UV rays, and thus the polarized light splitting element 100 may maintain an excellent polarization degree without transformation.

In addition, as long as the light absorbing material has the refractive index and extinction coefficient in the above ranges, various kinds of materials known in the related art may be used. The light absorbing material may be, but is not limited to, silicon, titanium oxide, zinc oxide, zirconium oxide, tungsten, tungsten oxide, gallium arsenic, gallium antimonide, aluminum gallium arsenic, cadmium telluride, chromium, molybdenum, nickel, gallium phosphide, indium gallium arsenic, indium phosphide, indium antimonide, cadmium zinc telluride, tin oxide, cesium oxide, strontium titanate, silicon carbide, iridium, iridium oxide or zinc selenium telluride.

In one example, a dielectric material may be present in the concave part 142 of the concavo-convex portion 140. The exemplary dielectric material may have a refractive index with respect to light having a wavelength of 250 to 350 nm of 1 to 3. The dielectric material may be, but is not particularly limited to, silicon oxide, magnesium fluoride, silicon nitride or air as long as it has the refractive index in the above range. In one example, when the dielectric material is air, the concave part 142 of the concavo-convex portion 140 may be a substantially empty space.

In one example, the substrate 110 included in the polarized light splitting element 100 and used to support the concavo-convex portion 140 may be a substrate formed of a material such as quartz, UV ray transmitting glass, polyvinyl alcohol (PVA), polycarbonate or ethylene vinylacetate (EVA). The exemplary substrate 110 may have a UV transmittance of 70, 80 or 90% or more, and when the transmittance is in the above range, a UV transmittance of the polarized light splitting element is enhanced and thus a photoalignment layer having an excellent photoalignment rate can be manufactured. For example, quartz having an excellent light transmittance of 85 to 90% or more in the visible region up to the UV region of 200 nm and strong to long-term radiation of UV rays and heat emitted from a lamp may be used as the substrate 110.

The extinction ratio of the exemplary polarized light splitting element 100 may be 2 or more, for example, 5, 10, 50, 100 or 500 or more. The upper limit of the extinction ratio may be, but is not particularly limited to, for example, 2000, 1500 or 1000 or less in consideration of the manufacturing process and economic feasibility. In one example, the polarized light splitting element 100 may have an extinction ratio in a short wavelength, for example, in the range of 250 to 350 nm, of 2 to 2000, for example, 5 to 1500, 10 to 1500, 50 to 2000, 500 to 1500 or 100 to 2000. Due to the extinction ratio in the above range, the polarized light splitting element 100 may exhibit excellent polarization performance in the visible region as well as the UV region. For example, when the height of the grid constituting the polarized light splitting element 100 is increased, the extinction ratio may be enhanced to more than 2000, but the polarized light splitting element substantially having an extinction ratio of 2000 or more has no practical use. When a height is increased at the same pitch, an aspect ratio is increased, and therefore productivity during the process may be considerably degraded.

Still another aspect of the present application provides a device including the polarized light splitting element, for example, a light radiating device. The exemplary device may include an apparatus in which the polarized light splitting element and an object to be irradiated are loaded.

Here, the polarized light splitting element may be a polarizing plate. The polarizing plate may be used to generate linearly polarized light from light radiated from a light source. The polarizing plate may be included in the device such that light radiated from the light source may be incident on the polarizing plate, and then the light transmitted through the polarizing plate may be radiated to the mask. In addition, for example, when the device includes a light collector, the polarizing plate may be present at a location in which light radiated from the light source is collected to the light collector, and then incident on the polarizing plate.

The polarizing plate may be any one capable of generating linearly polarized light from the light radiated from the light source without particular limitation. As such a polarizing plate, a glass plate or wire grid polarizing plate disposed at Brewster's angle may be used.

In addition, the device may further include a photoalignment mask between the apparatus in which the object to be irradiated is loaded and the polarized light splitting element.

Here, the mask may be installed at a distance to a surface of the object to be irradiated loaded in the apparatus of approximately 50 mm or less. The distance may be, for example, more than 0 mm, or 0.001, 0.01, 0.1 or 1 mm or more. In addition, the distance may be 40, 30, 20 or 10 mm or less. The distance from the mask to the surface of the object to be irradiated may be designed to various combinations of the upper and lower limits thereof.

Here, a kind of the apparatus to which the object to be irradiated is loaded is not particularly limited, and all kinds of apparatuses designed such that the object to be irradiated may be stably maintained during the radiation of light may be included.

In addition, the device may further include a light source capable of radiating light to a mask. The light source may be any one capable of radiating light in the direction of the mask depending on its purpose without particular limitation. For example, when alignment of the photoalignment layer or exposure of a photoresist is to be performed by light guided to an opening of the mask, as a light source capable of radiating UV rays, a high-pressure mercury UV lamp, a metal halide lamp or a gallium UV lamp may be used.

The light source may include one or more light irradiation means. When a plurality of light irradiation means are included, the number or arrangement of the irradiation means is not particularly limited. When the light source includes a plurality of the light irradiation means, the light irradiation means have at least two columns. A light irradiation means disposed on any one of the at least two columns may overlap a light irradiation means disposed on another column adjacent to the previous column.

The overlapping of the light irradiation means may refer to the case in which a line connecting centers of the light irradiation means disposed on any one of the at least two columns and a light irradiation means disposed on another column adjacent to the previous column is formed in a direction (direction inclined at a predetermined angle) parallel to a direction vertical to each column, and irradiation areas of the light irradiation means overlap in a certain part in directions vertical to the respective columns.

FIG. 5 is a diagram explaining arrangement of the light irradiation means. In FIG. 5, a plurality of the light irradiation means 10 are disposed by forming two columns, that is, column A and column B. Among the light irradiation means of FIG. 5, one represented as 101 is referred to as a first light irradiation means, and one represented as 102 is referred to as a second light irradiation means, the line (P) connecting the centers of the first and second light irradiation means is formed parallel to the line (C) formed in the direction vertical to the directions of columns A and B. In addition, the irradiation area of the first light irradiation means overlaps the irradiation area of the second light irradiation means by the range of Q in a direction vertical to the directions of columns A and B.

According to the arrangement described above, an amount of light radiated by the light source may be uniformly maintained. Here, a degree of overlapping one light irradiation means with another light irradiation means, for example, a length of Q in FIG. 5, is not particularly limited. For example, the overlapping degree, for example, a diameter of the light irradiation means, may be approximately ⅓ to ⅔ of L.

The device may further include at least one light collector to control the amount of light radiated from the light source. The light collector may be included in the device to radiate collected light to the polarized light splitting element and the mask after the light radiated from the light source is incident to the light collector and then collected. As the light collector, a component conventionally used in the related art may be used as long as it is formed to collect light radiated from the light source. As the light collector, a lenticular lens layer may be used.

FIG. 6 is a diagram of an example of a light radiating device. The device of FIG. 8 includes an apparatus 60 in which a light source 10, a light collector 20, a polarizing plate 30, a mask 40 and an object to be irradiated 50 are sequentially loaded. In the device of FIG. 6, light radiated from the light source 10 is incident on the light collector 20, collected, and then incident again on the polarizing plate 30. The light incident on the polarizing plate 30 may be generated into linearly-polarized light, incident again on the mask 40 by being guided by an opening and radiated to a surface of the object to be irradiated 50.

Yet another aspect of the present application provides a method of radiating light. The exemplary method may be performed using the light radiating device described above. For example, the method may include loading an object to be irradiated to an apparatus in which the object to be irradiated is loaded and radiating light to the object to be irradiated via the polarized light splitting element and the mask.

In one example, the object to be irradiated may be a photoalignment layer. In this case, the light irradiation method may be a method of manufacturing an orientationally-ordered photoalignment layer. For example, the photoalignment layer exhibiting a photoalignment characteristic may be manufactured by orientationally ordering a photosensitive material included in the photoalignment layer in a predetermined direction by radiating linearly-polarized light via the polarized light splitting element and the mask while the photoalignment layer is fixed to the apparatus.

A kind of photoalignment layer capable of being applied to the method is not particularly limited. In the related art, various kinds of photoaligned compounds capable of being used to form a photoalignment layer are known as a compound including a photosensitive residue in the corresponding art, and all of the known materials may be used to form a photoalignment layer. As a photoaligned compound, a compound orientationally ordered by trans-cis photoisomerization; a compound orientationally ordered by chain scission or photo-destruction such as photo-oxidation; a compound orientationally ordered by photocrosslinking or photopolymerization such as [2+2] cycloaddition, [4+4] cycloaddition or photodimerization; a compound orientationally ordered by photo-Fries rearrangement; or a compound orientationally ordered by ring opening/closure may be used. As a compound orientationally ordered by trans-cis photoisomerization, an azo compound such as sulfonate diazo dye or azo polymer or a stilbene compound may be used, and as a compound orientationally ordered by photo-destruction, cyclobutane-1,2,3,4-tetracarboxylic dianhydride, aromatic polysilane or polyester, polystyrene or polyimide may be used. In addition, as a compound orientationally ordered by photocrosslinking or photopolymerization, a cinnamate compound, a coumarin compound, a cinnamamide compound, a tetrahydrophthalimide compound, a maleimide compound, a benzophenone compound or a diphenylacetylene compound, or a compound having a chalconyl or anthracenyl residue (hereinafter, a chalconyl or anthracenyl compound) as a photosensitive residue may be used, as a compound orientationally ordered by photo-Fries rearrangement, an aromatic compound such as a benzoate compound, a benzoamide compound or a methylacrylamidoacryl methacrylate compound may be used, and as a compound orientationally ordered by ring opening/closure, a compound orientationally ordered by ring opening/closure of a [4+2]π-electronic system such as a spiropyran compound may be used, but the present application is not limited thereto. The photoalignment layer may be formed through a known method using such a photoaligned compound. For example, the photoalignment layer may be formed on a suitable supporting base using the compound, and the photoalignment layer may be applied to the method when transferred by an apparatus capable of loading an object to be irradiated, for example, a roll.

In the method, the photoalignment layer to which light is radiated via the polarized light splitting element and the mask may be a primarily aligned photoalignment layer. Primary alignment may be performed by radiating UV rays linearly polymerized in a certain direction to the photoalignment layer, for example, an entire surface of the photoalignment layer, through the polarized light splitting element before radiating light via the mask. While light is radiated to the primarily aligned photoalignment layer via the mask, if light polarized in a different direction from the primary alignment is radiated, light is radiated only to a region of the photoalignment layer corresponding to an opening, and the photoaligned compound is orientationally reordered. Therefore, a photoalignment layer in which a direction of orientationally ordering the photoaligned compound is patterned may be manufactured.

To orient the photoalignment layer, when linearly polarized UV rays are radiated once or more, the alignment of an orientation layer is finally determined by a direction of the radiated polarizing light. Accordingly, when primary alignment is performed by radiating UV rays linearly polarized in a certain direction to the photoalignment layer through the polarized light splitting element, and only a predetermined part is exposed to light linearly polarized in a different direction from that used in the primary alignment, a direction of the alignment layer may be changed to a direction different from that in the primary alignment only in a predetermined part to which light is radiated. As a result, a photoalignment layer having at least two different kinds of aligned regions with different patterns or alignment directions, which includes at least a first orientation region having a first alignment direction and a second orientation region having a second alignment direction different from the first alignment direction, may be formed.

In one example, an angle between a polarizing axis of linearly polarized UV rays radiated in the first orientation and a polarizing axis of linearly polarized UV rays radiated in the second orientation performed via the mask may be vertical. Here, “vertical” may refer to substantially vertical. The photoalignment layer manufactured by controlling polarizing axes of light radiated in the first and second alignments may be used in an optical filter capable of realizing a three-dimensional image.

For example, an optical filter may be manufactured by forming a liquid crystal layer on the photoalignment layer formed as described above. A method of forming a liquid crystal layer is not particularly limited, and may include performing crosslinking or polymerization by radiating light to a layer of liquid crystal compound after coating and orienting a liquid crystal compound crosslinked or polymerized by light on the photoalignment layer. Through the above-described operation, the layer of liquid crystal compound may be aligned along the alignment of the photoalignment layer and fixed, thereby manufacturing a liquid crystal film including at least two different kinds of regions having different alignment directions.

A kind of the liquid crystal compound applied to the photoalignment layer may be suitably selected depending on the use of the optical filter without particular limitation. For example, when the optical filter is a filter to realize a three-dimensional image, the liquid crystal compound may be a liquid crystal compound capable of forming a liquid crystal polymer layer oriented according to an alignment pattern of the underlying alignment layer and exhibiting λ/4 retardation characteristics by photocrosslinking or photopolymerization. The term “λ/4 retardation characteristics” may refer to characteristics capable of retarding incident light by ¼ times a wavelength thereof. When such a liquid crystal compound is used, an optical filter capable of splitting incident light into left-circular polarized light and right-circular polarized light may be manufactured.

A method of coating a liquid crystal compound and performing alignment, that is, orientational ordering along an orientation pattern of the underlying alignment layer, or a method of crosslinking or polymerizing an orientationally ordered liquid crystal compound is not particularly limited. For example, the alignment may be performed by maintaining a liquid crystal layer at a suitable temperature at which a compound can exhibit liquid crystallinity depending on the kind of liquid crystal compound. In addition, the crosslinking or polymerization may be performed by radiating light to a level capable of inducing suitable crosslinking or polymerization depending on the kind of liquid crystal compound to the liquid crystal layer.

### BRIEF DESCRIPTION OF THE DRAWINGS

The above and other objects, features and advantages of the present application will become more apparent to those of ordinary skill in the art by describing in detail exemplary embodiments thereof with reference to the adhered drawings, in which:

FIG. 1 is a diagram sequentially illustrating a method of manufacturing a UV ray polarized light splitting element;

FIG. 2 is a diagram sequentially illustrating another method of manufacturing a UV ray polarized light splitting element;

FIG. 3 is a diagram of a polarized light splitting element;

FIG. 4 is a schematic diagram of a top surface of the polarized light splitting element;

FIG. 5 is a diagram illustrating arrangement of a light irradiation means;

FIG. 6 is a diagram of a light radiating device;

FIGS. 7 and 8 are SEM images of polarized light splitting elements manufactured according to Examples 1 and 2; and

FIG. 9 is a graph showing comparison of polarized light splitting elements manufactured according to Examples 1 and 2 and Comparative Example.

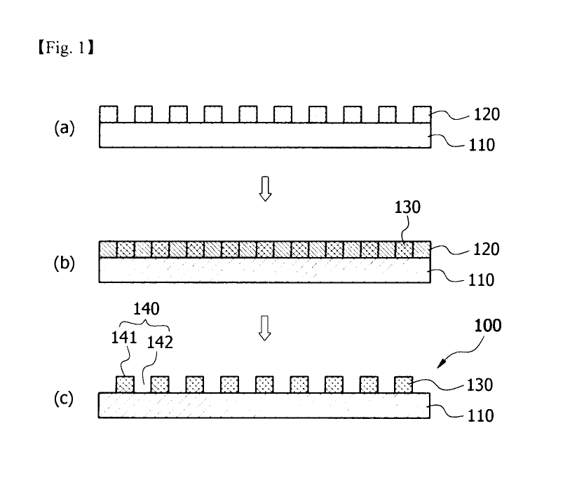

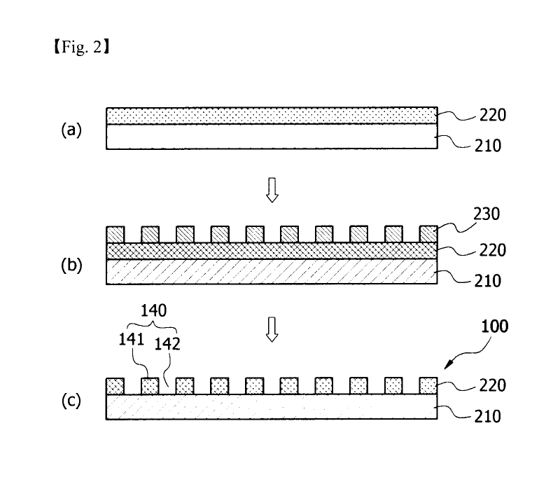

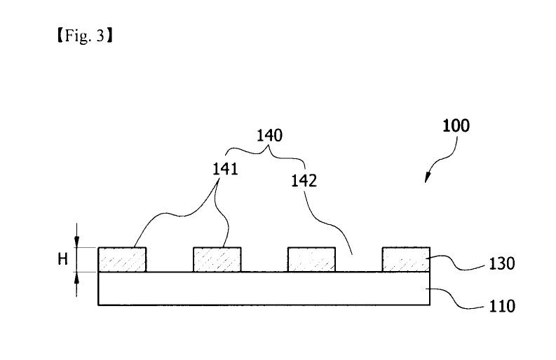

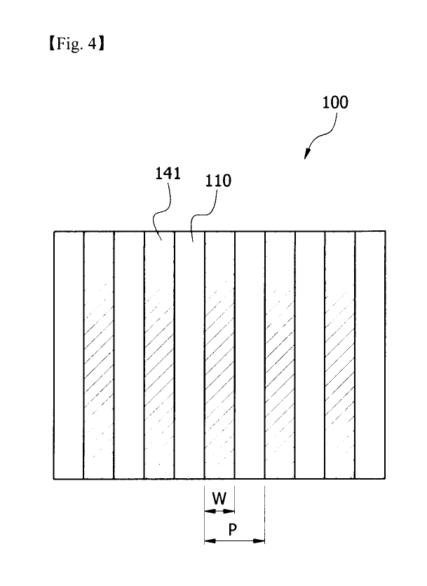

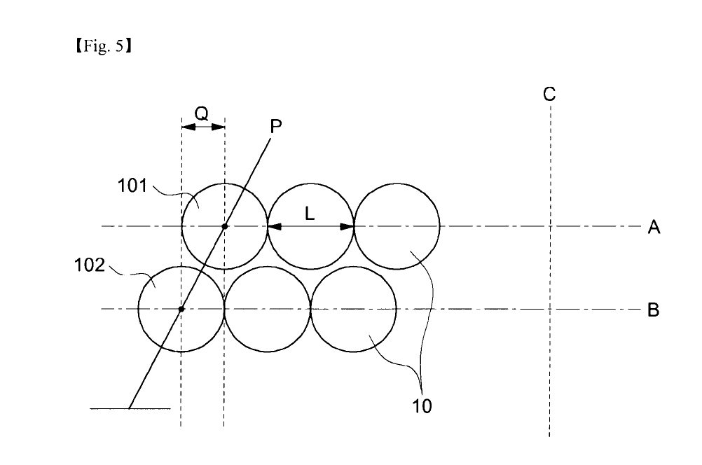

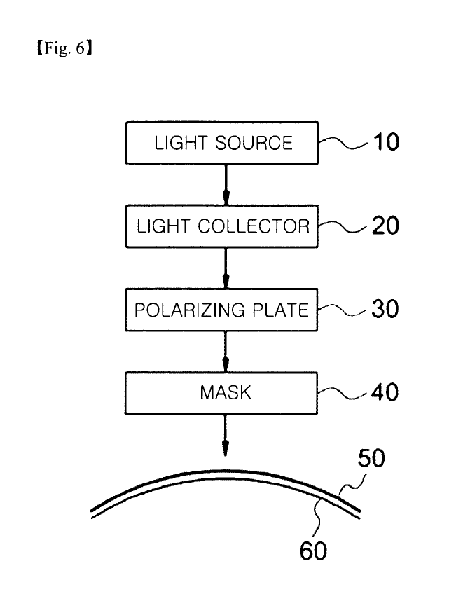

### DETAILED DESCRIPTION OF EXEMPLARY EMBODIMENTS

Hereinafter, exemplary embodiments of the present application will be described in detail. However, the present application is not limited to the embodiments disclosed below, but can be implemented in various forms. The following embodiments are described in order to enable those of ordinary skill in the related art to embody and practice the present application.

Hereinafter, a polarized light splitting element of the present application will be described with reference to Examples and Comparative Examples in detail. However, the scope of the polarized light splitting element is not limited to the following Examples.

### Preparation Example

### Preparation of Sol-Gel Coating Solution

A sol-gel coating solution was prepared by mixing 1.25 ml of Ti-isopropoxide which was a precursor of titanium dioxide with 2 ml of hydrochloric acid which was a catalyst in 50 ml of isopropyl alcohol which was a solvent in a glove box filled with nitrogen.

### Example

### Manufacture of UV Ray-Absorption-Type Polarized Light Splitting Element

### Example 1

A resist layer was formed to a thickness of 100 nm by coating an acryl-based resist (MR8010R produced by Microresist) on a 5 mm-thick quartz substrate. A stamper having a grid having a 75 nm gap previously manufactured was in contact with a surface of the resist layer, heated at 160° C. for 20 minutes, and pressed with a pressure of 40 bars, thereby transferring the grid of the stamper to the resist layer.

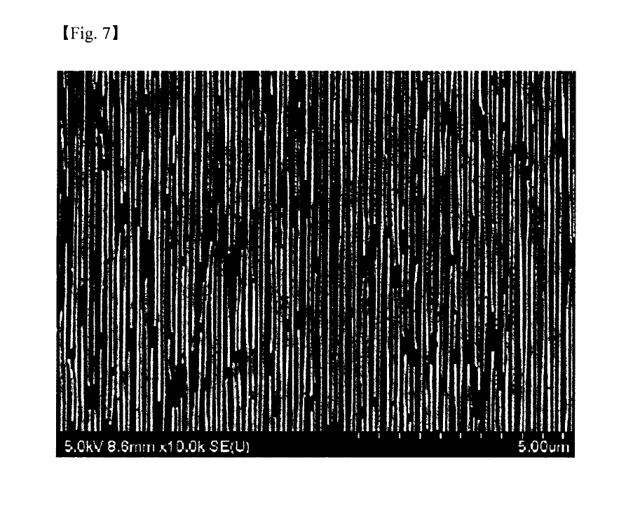

Afterward, a residue of the resist layer present in a concave part of an imprinted pattern was removed, thereby preparing a resist having a grid at a pitch of 150 nm. The sol-gel coating solution prepared in Preparation Example 1 was uniformly filled in a gap of the resist grid by spin-coating the sol-gel coating solution at 2000 rpm. Afterward, gelation was performed by leaving the grid under conditions of room temperature and a relative humidity of 65% to form titanium oxide (TiO₂) by hydrolysis and condensation through a reaction with moisture in the air. Subsequently, titanium isopropoxide filled in the gap of the resist grid was formed into titanium dioxide having an anatase crystal structure by thermally treating a substrate at 400° C. and removing the resist, thereby manufacturing a UV ray polarized light splitting element including titanium dioxide in a convex part which had a height (H) of 50 nm, a width (W) of 75 nm and a pitch (P) of 150 nm. FIG. 7 is an SEM image of an absorption-type polarized light splitting element manufactured according to Example 1.

### Example 2

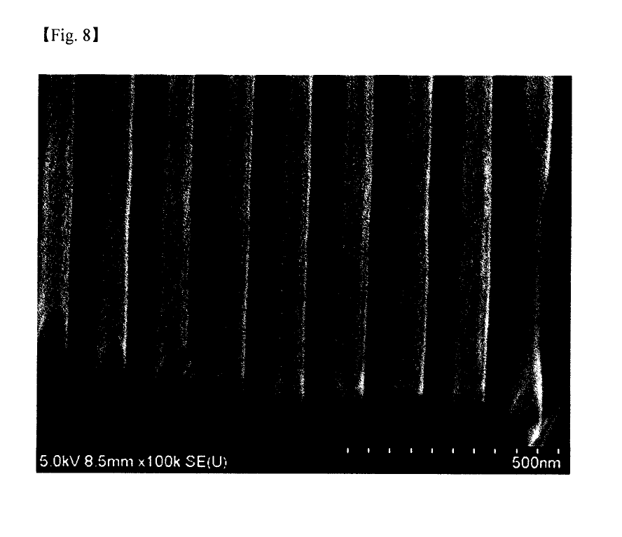

A 5 mm-thick quartz substrate was spin-coated with the sol-gel coating solution prepared in Preparation Example 1 at 2000 rpm, and gelated under conditions of room temperature and a relative humidity of 65% to form titanium oxide (TiO₂) by hydrolysis and condensation through a reaction with moisture in the air. Afterward, a resist layer having a thickness of 100 nm was formed by coating an acryl-based resist (MR8010R produced by Microresist) on the titanium oxide layer. A stamper having a grid having a 75 nm gap previously manufactured was in contact with a surface of the resist layer, heated at 160° C. for 20 minutes, and pressed with a pressure of 40 bars, thereby transferring the grid of the stamper to the resist layer. Afterward, a residue of the resist layer present in a concave part of an imprinted pattern was removed, thereby preparing a resist having a grid at a pitch of 150 nm. The titanium oxide layer was patterned by performing an etch back process using the resist as an etching mask, thereby manufacturing a UV ray polarized light splitting element including titanium dioxide in a convex part which had a height (H) of 50 nm, a width (W) of 75 nm and a pitch (P) of 150 nm. FIG. 8 is a SEM image of an absorption-type polarized light splitting element manufactured according to Example 2.

### Comparative Example

An aluminum layer was vacuum-deposited to a thickness of 150 nm on a 5 mm-thick quartz substrate by sputtering. Afterward, a resist layer having a thickness of 100 nm was formed by coating an acryl-based resist (MR8010R produced by Microresist) on the aluminum layer. A stamper having a grid having a 75 nm gap previously manufactured was in contact with a surface of the resist layer, heated at 160° C. for 20 minutes, and pressed with a pressure of 40 bars, thereby transferring the grid of the stamper to the resist layer. Afterward, a residue of the resist layer present in a concave part of an imprinted pattern was removed, thereby preparing a resist having a grid at a pitch of 150 nm. The titanium oxide layer was patterned by performing an etch back process using the resist as an etching mask, thereby manufacturing a UV ray polarized light splitting element including titanium dioxide in a convex part which had a height (H) of 50 nm, a width (W) of 75 nm and a pitch (P) of 150 nm.

### Experimental Example

Physical properties of the polarized light splitting elements manufactured in Examples 1 and 2 and Comparative Example were evaluated by the following methods.

Measuring Method 1. Measurement of Refractive Index and Extinction Coefficient of Convex Part

A refractive index and extinction coefficient of the convex part of the polarized light splitting element were measured by radiating light having a wavelength of 300 nm to the polarized light splitting element manufactured in Examples or Comparative Example using spectroscopic ellipsometry and oscillation modeling. The results are shown in Table 1.

TABLE 1

| | | Real Optical Constant | |
|---|---|---|---|
| | | Refractive | Extinction |
| Wavelength (nm) | Light Absorbing Material | Index | Coefficient |
| 250 | TiO₂ | 2.21 | 1.65 |
| | Al | 0.20 | 3.0 |
| 275 | TiO₂ | 2.96 | 1.68 |
| | Al | 0.23 | 3.3 |
| 300 | TiO₂ | 3.51 | 1.07 |
| | Al | 0.28 | 3.64 |
| 325 | TiO₂ | 3.45 | 0.44 |
| | Al | 0.33 | 3.95 |
| 350 | TiO₂ | 3.19 | 0.14 |
| | Al | 0.39 | 4.3 |

Measuring Method 2. Measurement of Transmittance

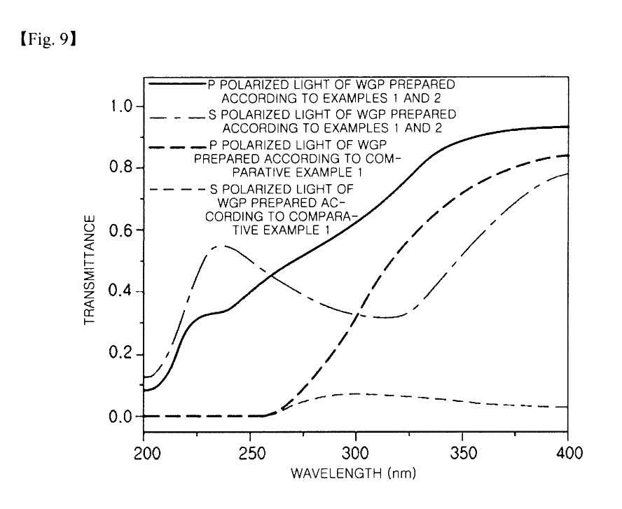

Transmittance of P and S polarized lights of the UV ray polarized light splitting elements were manufactured according to Examples 1 to 3 and Comparative Example in a wavelength band of 200 to 400 nm using an Axo-scan polarized light transmission and reflection spectrum measuring apparatus. The measurement results are show in the graph of FIG. 9. In FIG. 9, the x axis is a wavelength of light (200 to 400 nm) and the y axis is light transmittance.

As shown in Table 1, while the convex part of the polarized light splitting element formed by depositing aluminum in Comparative Example has a refractive index with respect to light having a wavelength of 300 nm of 0.28, which is less than 1 and an extinction coefficient of 3.64, the convex part including titanium dioxide formed by a solution process in Example has a refractive index with respect to light having a wavelength of 300 nm of 3.51 and an extinction coefficient of 1.07, which satisfies the refractive index range of 1 to 10, and the extinction coefficient range of 0.5 to 10.

In addition, referring to FIG. 9, it can be confirmed that the polarized light splitting elements manufactured according to Experimental Examples 1 and 2 have excellent polarization characteristics in the UV region compared to those of Comparative Example. Particularly, in the region of 250 nm or less, the polarized light splitting element according to Comparative Example does not have a polarization characteristic, but the polarized light splitting elements manufactured according to Experimental Examples 1 and 2 have excellent polarization characteristics.

A method of manufacturing a polarized light splitting element according to the present application has a simple manufacturing process and a low production cost, and can be used to easily manufacture a large-scale UV ray polarized light splitting element. In addition, since the polarized light splitting element of the present application has excellent durability to UV rays and heat and a low pitch dependency on a polarization characteristic, performance of the manufacturing process is facilitated and excellent polarity and extinction ratio can be realized in a short wavelength region

While the invention has been shown and described with reference to certain exemplary embodiments thereof, it will be understood by those skilled in the art that various changes in form and details may be made therein without departing from the scope of the invention as defined by the appended claims.

1. A method of manufacturing a UV ray polarized light splitting element, comprising:
forming a convex part having a refractive index of 1 to 10 and an extinction coefficient of 0.5 to 10 with respect to light having a wavelength of 300 nm on a substrate using a solution process.

2. The method according to claim 1, wherein the solution process includes a sol-gel process.

3. The method according to claim 1, where the convex part is formed by forming a resist in a grid type having regular gaps on the substrate, and coating a coating solution on the gap of the grid.

4. The method according to claim 1, wherein the convex part is formed by forming a layer of coating solution including a light absorbing material on the substrate, forming a resist on the layer of coating solution and performing etching.

5. The method according to claim 3, wherein the coating solution includes light absorbing particles having an average diameter of 3 to 100 nm or a precursor of a light absorbing material.

6. The method according to claim 5, wherein the light absorbing particles include at least one selected from the group consisting of titanium oxide particles, zinc oxide particles, zirconium oxide particles, tungsten oxide particles, tin oxide particles, cesium oxide particles, strontium titanium oxide particles, silicon carbide particles, iridium particles, iridium oxide particles and silicon particles.

7. The method according to claim 5, wherein a content of the light absorbing particles of the coating solution is 1 to 30 parts by weight.

8. The method according to claim 5, wherein the precursor of a light absorbing material includes at least one selected from the group consisting of titanium alkoxide, zirconium alkoxide, tungsten alkoxide, tin alkoxide, zinc alkoxide, cesium alkoxide, iridium alkoxide and silicon alkoxide.

9. The method according to claim 5, wherein a content of the precursor of a light absorbing material of the coating solution is 1 to 40 parts by weight.

10. The method according to claim 5, wherein the coating solution includes a precursor of a light absorbing material and light absorbing particles, the light absorbing particles including a material the same as a light absorbing material formed from the precursor of a light absorbing material.

11. The method according to claim 2, further comprising:
maintaining the coated coating solution at a temperature of 60 to 300° C.

12. The method according to claim 2, wherein the resist is formed by photolithography, nano imprint lithography, soft lithography or interference lithography.

13. The method according to claim 2, further comprising removing the resist after forming the convex part.

14. The method according to claim 13, wherein the resist is removed at a temperature of 250 to 900° C.

15. The method according to claim 1, wherein the convex part is formed to have a pitch of 50 to 200 nm.

16. The method according to claim 15, wherein the convex part is formed to have a ratio (W/P) of a width (W) to the pitch (P) of 0.2 to 0.8.

17. The method according to claim 15, wherein the convex part is formed to have a ratio (H/P) of a height (H) to the pitch (P) of 0.3 to 1.5.

18. A UV ray polarized light splitting element comprising a grid formed by spacing a convex part having a refractive index of 1 to 10 and an extinction coefficient of 0.5 to 10 with respect to light having a wavelength of 300 nm apart at a regular gap.
